(19) United States
(12) Patent Application Publication
(10) Pub. No.: US 2023/0189391 A1
(43) Pub. Date: Jun. 15, 2023

(54) METHOD AND DEVICE FOR MANAGING SIDELINK TRANSMISSION

(71) Applicant: ZTE CORPORATION, Shenzhen (CN)

(72) Inventors: Wei LUO, Shenzhen (CN); Lin CHEN, Shenzhen (CN); Boyuan ZHANG, Shenzhen (CN)

(73) Assignee: ZTE CORPORATION, Shenzhen (CN)

(21) Appl. No.: 18/105,568

(22) Filed: Feb. 3, 2023

Related U.S. Application Data
(63) Continuation of application No. PCT/CN2020/107329, filed on Aug. 6, 2020.

(51) Int. Cl. H04W 76/28; H04L 1/1812

(52) U.S. Cl. CPC H04W 76/28; H04L 1/1812

(57) ABSTRACT

This disclosure relates to methods and devices for configuring discontinuous reception for sidelink transmission between communication terminals in a wireless communication network. In one implementation, the method may include receiving a first discontinuous reception (DRX) configuration information from a wireless network access node, receiving a second DRX configuration information from a second user equipment. The method may further include obtaining a DRX configuration scheme for a sidelink communication between the first user equipment and a second user equipment based on the first DRX configuration information and the second DRX configuration information.

### TECHNICAL FIELD

This disclosure is directed generally to wireless communications and particularly to manage sidelink transmission between communication terminals including vehicles.

### BACKGROUND

Sidelink is a unilateral wireless communication service, i.e., the communication between the communication terminals. Vehicle networking refers to a large scale system for wireless communication and information exchange among vehicles, pedestrians, roadside equipments, and internet in accordance with agreed communication protocols and data exchange standards. The vehicle networking communications enable the vehicles to gain driving safety, improve traffic efficiency, and acquire convenience or entertainment information. The vehicle networking communication may be categorized into three types as per the objects of wireless communication: the communication between vehicles, i.e., vehicle-to-vehicle (V2V); the communication between vehicles and roadside equipments/network infrastructures, i.e., vehicle-to-infrastructure/vehicle-to-network (V2I/V2N); and the communication between vehicles and pedestrians, i.e., vehicle-to-pedestrian (V2P). These types of communications collectively are referred to as vehicle-to-everything (V2X) communication.

In the V2X communication research of 3rd Generation Partnership Project (3GPP), the sidelink based V2X communication method between user equipments is one of the manners to implement the V2X standard, in which traffic data is directly transmitted from a source user equipment to a destination user equipment via an air interface without forwarding by the base station and the core network, as shown in FIG. 1. This V2X communication is referred to as PC5-based V2X communication or V2X sidelink communication.

With the technology advancement and development of the automation industry, the scenarios for V2X communications are further diversified and require higher performance. The advanced V2X services include vehicle platooning, extended sensors, advanced driving (semi-automated driving and full-automated driving), and remote driving. The desired performance requirements may include: supporting data packet with the size of 50 to 12000 bytes, transmission rate with 2 to 50 messages per second, the maximum end-to-end delay of 3 to 500 milliseconds, reliability of 90% to 99.999%, data rate of 0.5 to 1000 Mbps, as well as transmission range of 50 to 1000 meters.

### SUMMARY

This disclosure is directed to methods, systems, and devices related to wireless communication, and more specifically, to configure discontinuous reception for sidelink transmission between communication terminals.

In one embodiment, a method performed by a first user equipment in a wireless communication network is disclosed. The method may include receiving a first discontinuous reception configuration information from a wireless network access node, and receiving a second discontinuous reception configuration information from a second user equipment. The method may further include obtaining a discontinuous reception configuration scheme for a sidelink communication between the first user equipment and a second user equipment based on the first discontinuous reception configuration information and the second discontinuous reception configuration information.

In one embodiment, a method performed by a first user equipment in a wireless communication network is disclosed. The method may include receiving a discontinuous reception configuration information from a wireless network access node or a second user equipment. The method may further include obtaining a discontinuous reception configuration scheme for a sidelink communication between the first user equipment and a second user equipment based on the DRX configuration information.

In one embodiment, a method performed by a second user equipment in a wireless communication network is disclosed. The method may include transmitting a second DRX configuration information to a first user equipment, which may assist the first user equipment to determine a DRX configuration scheme for a sidelink communication between the first user equipment and a second user equipment based on a first DRX configuration information received from a wireless network access node and the second DRX configuration information.

In another embodiment, a device for wireless communication may include a memory storing instructions and a processing circuitry in communication with the memory. When the processing circuitry executes the instructions, the processing circuitry is configured to carry out the above methods.

In another embodiment, a computer-readable medium comprising instructions which, when executed by a computer, cause the computer to carry out the above methods.

The above and other aspects and their implementations are described in greater detail in the drawings, the descriptions, and the claims below.

### BRIEF DESCRIPTION OF THE DRAWINGS

FIG. 1 illustrates an example diagram of a wireless communication network in accordance with various embodiments.

FIG. 2 illustrates a flow diagram of a method for configuring discontinuous reception for sidelink transmission in accordance with an embodiment.

FIG. 3 illustrate flow diagram of a method for configuring discontinuous reception for sidelink transmission in accordance with an embodiment.

FIG. 4 illustrates a flow diagram of a method for configuring discontinuous reception for sidelink transmission in accordance with an embodiment.

### DETAILED DESCRIPTION

The technology and examples of implementations and/or embodiments in this disclosure can be used to improve performance in wireless communication systems. The term “exemplary” is used to mean “an example of” and unless otherwise stated, does not imply an ideal or preferred example, implementation, or embodiment. Section headers are used in the present disclosure to facilitate understanding and do not limit the disclosed technology in the sections only to the corresponding section. Please note that the implementations may, however, be embodied in a variety of different forms and, therefore, the covered or claimed subject matter is intended to be construed as not being limited to any of the embodiments to be set forth below. Please also note that the implementations may be embodied as methods, devices, components, or systems. Accordingly, embodiments of this disclosure may, for example, take the form of hardware, software, firmware or any combination thereof.

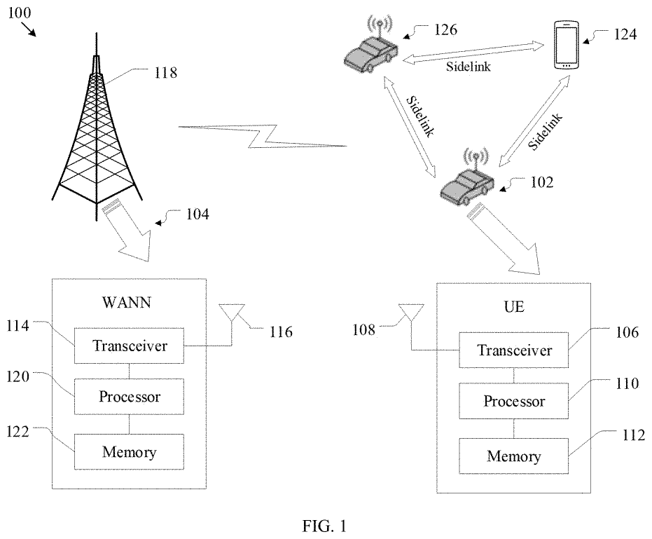

A wireless access network provides network connectivity between a user equipment (UE) and an information or data network such as a text, voice or video communication network, the Internet, and the like. An example wireless access network may be based on cellular technologies, which may further be based on, for example, 4G LTE or 5G NR technologies and/or formats. FIG. 1 shows an example system diagram of wireless communication network 100 including UEs 102, 124, and 126 as well as a wireless access network node (WANN) 104 according to various embodiments. The UEs 102, 124, and 126 may include but is not limited to a mobile phone, smartphone, tablet, laptop computer, a vehicle on-board communication equipment, roadside communication equipment, a smart electronics or appliance including an air conditioner, a television, a refrigerator, an oven, or other devices that are capable of communicating wirelessly over a network. The UEs may directly communicate with each other via the sidelinks. Take the UE 102 as an example, it may include transceiver circuitry 106 coupled to an antenna 108 to effect wireless communication with the wireless access network node 104 and the UEs 124/126. The transceiver circuitry 106 may also be coupled to a processor 110, which may also be coupled to a memory 112 or other storage devices. The memory 112 may store therein instructions or code that, when read and executed by the processor 110, cause the processor 110 to implement various ones of the methods described herein.

Similarly, the WANN 104 may include a base station or other wireless network access points capable of communicating wirelessly over a network with one or more UEs. The WANN 104 may comprise a 4G LTE base station, a 5G NR base station, a 5G central-unit base station, or a 5G distributed-unit base station. The WANN 104 may be configured to perform a corresponding set of wireless network functions. The set of wireless network functions between different types of wireless access network nodes may not be identical. The set of wireless network functions between different types of wireless access network nodes, however, may functionally overlap. The WANN 104 may include transceiver circuitry 114 coupled to an antenna 116, which may include an antenna tower 118 in various approaches, to effect wireless communication with the UEs 102, 124, or 126. The transceiver circuitry 114 may also be coupled to one or more processors 120, which may also be coupled to a memory 122 or other storage devices. The memory 122 may store therein instructions or code that, when read and executed by the processor 120, cause the processor 120 to implement various ones of the methods described herein.

For simplicity and clarity, only one WANN and three UEs are shown in the wireless communication network 100. It will be appreciated that multiple WANNs may exist in the wireless communication network 100, and each WANN may serve one or more UEs in the meantime. Besides UEs and WANNs, the network 100 may further comprise any other network nodes with different functions such as the network nodes in core network of the wireless communication network 100. In addition, while various embodiments will be discussed in the context of the particular example wireless communication network 100, the underlying principle applies to other applicable wireless communication networks.

In the sidelink communication such as V2X communication between UEs, the UEs need to frequently monitor a sidelink transmission resource pool of the UE, for example by way of sensing, so as to obtain sidelink transmission resource from the sidelink transmission resource pool, which incurs huge power consumption and low efficiency. One of the objectives of the present disclosure is to reduce the power consumption of the UEs in sidelink transmission. For example, the UE may be configured with discontinuous reception (DRX). The discontinuous reception is a method used in wireless communication to conserve the battery of the user equipments. The user equipment and the network may negotiate phases in which data transfer occurs. During other times the user equipment may turn its receiver off and enters a low power state. In this way, the power consumption of the user equipment may be saved.

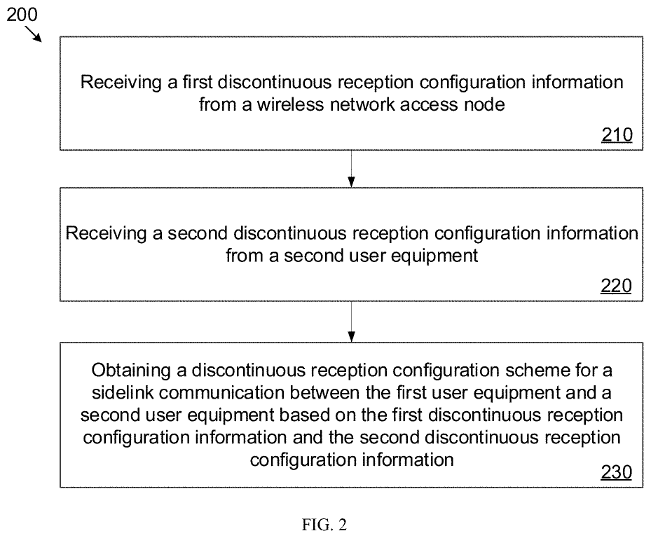

FIG. 2 illustrates an exemplary implementation 200 for configuring a sidelink DRX for sidelink transmission of the user equipments. By way of example, various operations of a first user equipment such as the UE 102 that configures the sidelink DRX for the sidelink communication link between the UE 102 and the second user equipment such as the UE 124 will be described with reference to FIG. 1 and FIG. 2. Herein, for purpose of explaining the present disclosure, the UE 102 may serve as a sidelink reception user equipment and the UE 124 may serve as a sidelink transmission user equipment.

The UE 102 may receive a first DRX configuration information from the wireless network access node such as the WANN 118 (210). For example, the UE 102 may receive the first DRX configuration information via a radio resource control (RRC) dedicated message or a broadcast message. the first DRX configuration information may be configured by the WANN 118. In an implementation, the first DRX configuration information may include a subset of DRX configuration parameters that are required to configure the sidelink DRX. For example, the first DRX configuration information may include DRX configuration parameters drx-LongCycleStartOffset, drx-LongCycle, and drx-StartOffset. In another implementation, the first DRX configuration information may include a complete set of DRX configuration parameters that are required to configure the sidelink DRX. The values of the DRX configuration parameters in the first DRX configuration information may be taken as be default values of DRX configuration parameters in configuring the sidelink DRX. Additionally or alternatively, the first DRX configuration information received from the WANN 118 may also be used to configure sidelink DRX for the sidelink communication between the UE 102 and other UEs such as the UE 126.

The UE 102 may receive a second DRX configuration information from the second user equipment such as the UE 124 (220). For example, the UE 102 may receive the second DRX configuration information via a PC5 RRC dedicated message or a broadcast message. The second DRX configuration information may be configured by the UE 124. Similar to the first DRX configuration information, the second DRX configuration may include a subset of a complete set of DRX configuration parameters for configuring the sidelink DRX. The second DRX configuration may include, for example, a time duration, an on duration time pattern, a first non-active timer, and a second non-active timer. The on duration time pattern may include a slot bitmap indicating the sidelink DRX on duration. In an implementation, the first DRX configuration information and the second DRX configuration information may include overlapping DRX configuration parameters though an overlapping DRX configuration parameter may be assigned with different values in the first DRX configuration information and the second DRX configuration information. Alternatively, there is not overlapping DRX configuration parameter in the first DRX configuration information and the second DRX configuration information.

Subsequently, the UE 102 may obtain a DRX configuration scheme for the sidelink communication between the UE 102 and the UE 124 based on the first DRX configuration information and the second DRX configuration information (230). The DRX configuration scheme may include a plurality of DRX configuration parameters. For example, the DRX configuration scheme may be defined with the data structure as below:

| | |
|---|---|
| DRX-Config1 ::= | SEQUENCE { |
| drx-onDurationTimer | CHOICE { |
| | subMilliSeconds INTEGER (1..31), |
| | milliSeconds ENUMERATED { |
| | ms1, ms2, ms3, ms4, ms5, ms6, ms8, ms10, ms20, |

ms30, ms40, ms50, ms60,

ms80, ms100, ms200, ms300, ms400, ms500, ms600,

ms800, ms1000 ms1200,

ms1600, spare8, spare7, spare6, spare5, spare4,

spare3, spare2, spare1 }

| | |
|---|---|
| | }, |
| drx-LongCycleStartOffset | CHOICE { |
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

},

| | |
|---|---|
| shortDRX | SEQUENCE { |
| drx-ShortCycle | ENUMERATED { |
| | ms2, ms3, ms4, ms5, ms6, ms7, ms8, ms10, ms14, |

ms16, ms20, ms30, ms32,

ms35, ms40, ms64, ms80, ms128, ms160, ms256,

ms320, ms512, ms640, spare9,

spare8, spare7, spare6, spare5, spare4, spare3, spare2,

spare1 },

| | |
|---|---|
| drx-ShortCycleTimer | INTEGER (1..16) |

}
OPTIONAL
}

| | |
|---|---|
| DRX-Config2 ::= | SEQUENCE { |
| drx-onDurationTimer | CHOICE { |
| | subMilliSeconds INTEGER (1..31), |
| | milliSeconds ENUMERATED { |
| | ms1, ms2, ms3, ms4, ms5, ms6, ms8, ms10, ms20, |

ms30, ms40, ms50, ms60,

ms80, ms100, ms200, ms300, ms400, ms500, ms600,

ms800, ms1000, ms1200,

ms1600, spare8, spare7, spare6, spare5, spare4,

spare3, spare2, spare1 }

| | |
|---|---|
| | }, |
| drx-InactivityTimer | ENUMERATED { |
| | ms0, ms1, ms2, ms3, ms4, ms5, ms6, ms8, ms10, ms20, |

ms30, ms40, ms50, ms60, ms80,

ms100, ms200, ms300, ms500, ms750, ms1280, ms1920,

ms2560, spare9, spare8,

| | |
|---|---|
| | spare7, spare6, spare5, spare4, spare3, spare2, spare1}, |
| drx-HARQ-RTT-TimerDL | INTEGER (0..56), |
| drx-HARQ-RTT-TimerUL | INTEGER (0..56), |
| drx-RetransmissionTimerDL | ENUMERATED { |
| | sl0, sl1, sl2, sl4, sl6, sl8, sl16, sl24, sl33, sl40, sl64, sl80, |

sl96, sl112, sl128,

sl160, sl320, spare15, spare14, spare13, spare12, spare11,

spare10, spare9,

spare8, spare7, spare6, spare5, spare4, spare3, spare2,

spare1},

| | |
|---|---|
| drx-RetransmissionTimerUL | ENUMERATED { |
| | sl0, sl1, sl2, sl4, sl6, sl8, sl16, sl24, sl33, sl40, sl64, sl80, |

sl96, sl112, sl128,

sl160, sl320, spare15, spare14, spare13, spare12, spare11,

spare10, spare9,

spare8, spare7, spare6, spare5, spare4, spare3, spare2,

spare1 },

| | |
|---|---|
| shortDRX | SEQUENCE { |
| drx-ShortCycle | ENUMERATED { |
| | ms2, ms3, ms4, ms5, ms6, ms7, ms8, ms10, ms14, |

ms16, ms20, ms30, ms32,

ms35, ms40, ms64, ms80, ms128, ms160, ms256,

ms320, ms512, ms640, spare9,

spare8, spare7, spare6, spare5, spare4, spare3, spare2,

spare1 },

| | |
|---|---|
| drx-ShortCycleTimer | INTEGER (1..16) |

}
OPTIONAL, -- Need R

| | |
|---|---|
| drx-SlotOffset | INTEGER (0..31) |

}

In an implementation, the UE 102 may combine DRX configuration parameters in the first DRX configuration information and DRX configuration parameters in the second DRX configuration information into the DRX configuration scheme. For example, the UE 102 may assign values of DRX configuration parameters in the second DRX configuration information to corresponding DRX configuration parameters in the DRX configuration scheme. In the case that the second DRX configuration information does not include a DRX configuration parameter corresponding to a specific DRX configuration parameter in the DRX configuration scheme, the UE 102 may search the first DRX configuration information for a DRX configuration parameter corresponding to the specific DRX configuration parameter, and then assign a value of the corresponding DRX configuration parameter in the first DRX configuration information to the specific DRX configuration parameter.

If a DRX configuration parameter in the DRX configuration scheme is not included in the second DRX configuration information, the UE 102 may assign a value of the same DRX configuration parameter in the first DRX configuration information to the DRX configuration parameter in the DRX configuration scheme. In other words, the values of the DRX configuration parameters in the first DRX configuration information serve as default values of corresponding DRX configuration parameters in the DRX configuration scheme.

In another implementation, where the UE 102 fails to receive the second DRX configuration information from the UE 124, the UE 102 may obtain the DRX configuration scheme for the sidelink communication between the UE 102 and the UE 104 based on the first DRX configuration information received from the WANN 118. For example, the UE 102 may simply use the first DRX configuration information received from the WANN 118 as the DRX configuration scheme. Similarly, where the UE 102 fails to receive the first DRX configuration information from the WANN 118, the UE 102 may obtain the DRX configuration scheme for the sidelink communication between the UE 102 and the UE 124 based on the second DRX configuration information received from the UE 124. For example, the UE 102 may simply use the second DRX configuration information received from the UE 124 as the DRX configuration scheme.

In a further implementation, as illustrated in FIG. 3, the UE 102 may receive a DRX configuration information only from the WANN 118 or the UE 124 (310). In this case, the UE 102 may obtain the DRX configuration scheme for the sidelink communication between the UE 102 and the UE 124 based on the received DRX configuration information (320).

Upon setting the sidelink DRX configuration scheme, the UE 102 may not have to continuously monitor the physical sidelink control channel (PSCCH). Instead, the UE may only monitor the PSCCH during the reception on duration, which may help reduce power consumption of the UE.

Optionally, The UE 102 may configure the sidelink DRX for the sidelink communication between the UE 102 and the UE 124 by taking into account the DRX configuration information received from a third UE. In an implementation, the UE 102 may receive a third DRX configuration information from a third user equipment such as the UE 126. Then, the UE 102 may determine the DRX configuration scheme based on the first DRX configuration information, the second DRX configuration information, and the third DRX configuration information. For example, the UE 102 may assign values of DRX configuration parameters in the second DRX configuration information to corresponding DRX configuration parameters in the DRX configuration scheme. In the case that the second DRX configuration information does not include a DRX configuration parameter corresponding to a specific DRX configuration parameter in the DRX configuration scheme, the UE 102 may search the first DRX configuration information and the third DRX configuration information for a DRX configuration parameter corresponding to the specific DRX configuration parameter, and then assign a value of the corresponding DRX configuration parameter in the first DRX configuration information to the specific DRX configuration parameter. For example, the UE 102 may first search the third DRX configuration information for the corresponding DRX configuration parameter. If the UE 102 fails to find the corresponding DRX configuration parameter in the third DRX configuration information, the UE 102 may search the first DRX configuration information for the corresponding DRX configuration parameter.

Optionally, prior to receiving the second DRX configuration information, the UE 102 may transmit the first DRX configuration information to the UE 124. The UE 124 may configure the second DRX configuration information based on the first DRX configuration information.

Optionally, prior to receiving the first DRX configuration information, the UE 102 may transmit a sidelink information of the UE 102 to the WANN 118. The sidelink information may include quality of service (QoS) information, destination identity information, and sidelink configuration assistant information such as traffic pattern information. In this way, the WANN 118 may configure the first DRX configuration information based on the sidelink information from the UE 102.

Optionally, the UE 102 may be configured with a sidelink DRX inactivity timer, DRX-Inactivity Timer, for the sidelink communication link between the UE 102 and a UE 124. When the sidelink DRX inactivity timer is running, the UE 102 may determine that DRX is not used for the sidelink communication link and thus perform the sidelink communication without DRX. When receiving an indication to enable the DRX for the sidelink communication link, the UE 102 may stop the sidelink DRX inactivity timer. For example, the UE 102 may stop the sidelink DRX inactivity timer when receiving a sidelink DRX command media access control (MAC) control element (CE) for the sidelink communication link.

Optionally, the WANN 118 may configure whether to allow the UE 102 to report a sidelink DRX preference for the sidelink communication link between the UE 102 and the UE 124 to the WANN 118 or the UE 124. Upon receiving, from the WANN 118, indication allowing the UE 102 to report a sidelink DRX preference to the WANN 118, the UE 102 may transmit, for example, an assistance information including the sidelink DRX preference for the sidelink communication link to the WANN 118. By way of example, a data structure for the sidelink DRX preference is illustrated as below. As indicated, the sidelink DRX preference may include, for example, preferred DRX inactivity timer, preferred DRX long cycle, preferred DRX short cycle, and preferred DRX short cycle timer.

| | |
|---|---|
| SL_DRX-Preference ::= | SEQUENCE { |
| preferredDRX-InactivityTimer | ENUMERATED { |
| | ms0, ms1, ms2, ms3, ms4, ms5, ms6, ms8, ms10, |

ms20, ms30, ms40, ms50, ms60, ms80,

ms100, ms200, ms300, ms500, ms750, ms1280,

ms1920, ms2560, spare9, spare8,

spare7, spare6, spare5, spare4, spare3, spare2,

spare1} OPTIONAL,

| | |
|---|---|
| preferredDRX-LongCycle | ENUMERATED { |
| | ms10, ms20, ms32, ms40, ms60, ms64, ms70, |

ms80, ms128, ms160, ms256, ms320, ms512,

ms640, ms1024, ms1280, ms2048, ms2560,

ms5120, ms10240, spare12, spare11, spare10,

spare9, spare8, spare7, spare6, spare5, spare4,

spare3, spare2, spare1 } OPTIONAL,

| | |
|---|---|
| preferredDRX-ShortCycle | ENUMERATED { |
| | ms2, ms3, ms4, ms5, ms6, ms7, ms8, ms10, ms14, |

ms16, ms20, ms30, ms32,

ms35, ms40, ms64, ms80, ms128, ms160, ms256,

ms320, ms512, ms640, spare9,

spare8, spare7, spare6, spare5, spare4, spare3,

spare2, spare1 } OPTIONAL,

| | |
|---|---|
| preferredDRX-ShortCycleTimer | INTEGER (1..16) OPTIONAL |

}

Similarly, upon receiving, from the WANN 118, indication allowing the UE 102 to report a sidelink DRX preference to the UE 124, the UE 102 may transmit, for example, an assistance information including a sidelink DRX preference for the sidelink communication link to the UE 124. Additionally or alternatively, the WANN 118 may configure whether to allow the UE 124 to receive the sidelink DRX preference from the UE 102. For example, the UE 124 may receive the sidelink DRX preference from the UE 102 only when receiving the permission from the WANN 118.

To prevent the UEs from reporting the sidelink DRX preference frequently, the WANN 118 may configure a DRX preference prohibit timer, e.g., drx-PreferenceProhibitTimer, for the UEs. In an implementation, the UE 102 may receive the DRX preference prohibit timer from the WANN 118. In the case that the DRX preference prohibit timer is running, the UE 102 may suspend transmitting the sidelink DRX preference to the WANN 118 until stop or expiration of the DRX preference prohibit timer. Additionally or alternatively, the UE 124 may configure a DRX preference prohibit timer for the UE 102. When the DRX preference prohibit timer configured by the UE 124 is running, the UE 102 may not transmit its sidelink DRX preference for the sidelink communication link between the UE 102 and the UE 124 to the UE 124 until the DRX preference prohibit timer is stopped or expired.

In another implementation, the DRX preference prohibit timer is not running. In this case, upon transmitting a sidelink DRX preference for the sidelink communication link to the UE 124 or the WANN 118, the UE 102 may start or restart the DRX preference prohibit timer.

Furthermore, the sidelink DRX retransmission is allowed between the UE 102 and the UE 124 when a sidelink hybrid automatic repeat request (HARQ) feedback for the sidelink communication link between the UE 102 and the UE 124 is enabled. In an implementation, the UE 102 may receive the indication to enable the HARQ feedback via a sidelink control information. The sidelink control information may be transmitted from the WANN 118 or the UE 124. As a reception UE, the UE 102 may have a plurality of HARQ processes, each of which corresponds to respective data packets to be transmitted via the sidelink communication link between the UE 102 and the UE 124. Upon receiving the indication that the HARQ feedback is enabled, the UE 102 may transmit sidelink HARQ feedback information for one or more of HARQ processes and then start respective sidelink DRX HARQ round trip time (RTT) timer, e.g., drx-HARQ-RTT-TimerRxSL, for each of the one or more HARQ processes. In the event that the UE 102 fails to decode a received data packet corresponding to a HARQ process, the UE 102 may start a sidelink DRX retransmission timer, e.g., drx-RetransmissionTimerRxSL, of the HARQ process when the sidelink DRX HARQ RTT timer of the HARQ process is expired. In this case, the UE 102 may assume that DRX is not used for the sidelink communication link during running of the sidelink DRX retransmission timer. The UE 102 may receive configurations for the sidelink DRX HARQ RTT timers and the sidelink DRX retransmission timer from the WANN 118 or the UE 124.

Optionally, the UE 102 may be configured with a physical uplink control channel to request for sidelink retransmission resources. To disable the downlink DRX for the downlink between the UE 102 and the WANN 118 during receiving sidelink retransmission resources from the WANN 118, the WANN 118 may configure a downlink sidelink HARQ RTT timer, e.g. drx-HARQ-RTT-TimerSL_DL, and a downlink sidelink retransmission timer, e.g., drx-RetransmissionTimerSL_DL for a sidelink HARQ process. In an implementation, the UE 102 may start the downlink sidelink HARQ RTT timer of the sidelink HARQ process after the transmission of the sidelink HARQ feedback indicating the retransmission is permitted. Then, the UE 102 may start the downlink sidelink retransmission timer of the sidelink HARQ process when the downlink sidelink HARQ RTT timer is expired. During the running of the downlink sidelink retransmission timer, the UE 102 may assume that the downlink DRX for the downlink between the UE 102 and the WANN 118 is not used. The UE 102 may receive the sidelink retransmission resources from the WANN 118 via the downlink without downlink DRX.

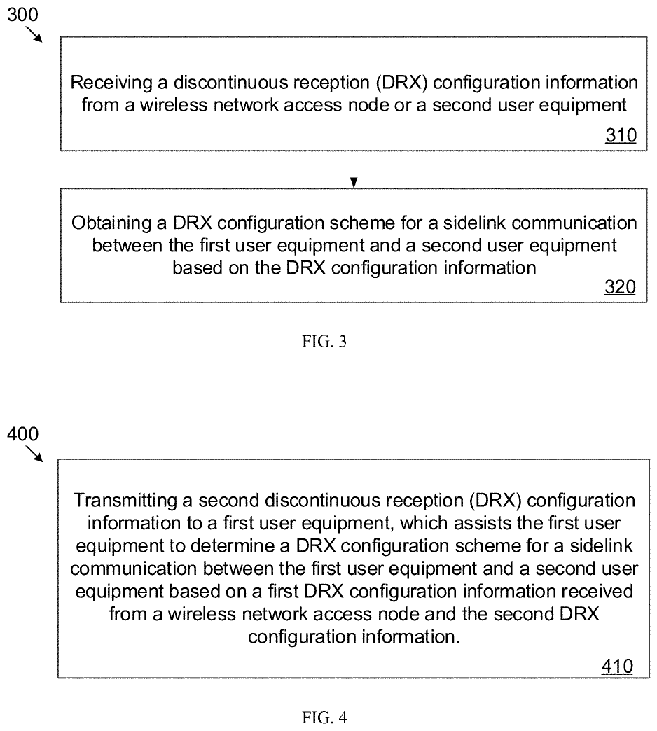

FIG. 4 illustrates an exemplary implementation 400 for assisting configuring a sidelink DRX for sidelink transmission of the user equipments. By way of example, the operations of the second user equipment such as the UE 124 that assists the first user equipment such as the UE 102 to configure the sidelink DRX for the sidelink communication link between the UE 102 and the UE 124 will be described with reference to FIG. 1 and FIG. 4.

The UE 124 may transmit the second DRX configuration information to the UE 102 (410). In an implementation, the UE 124 may configure the second DRX configuration information and transmit the second DRX configuration information to the UE 102 via a PC5 RRC dedicated message or a broadcast message.

The second DRX configuration information may facilitate the UE 102 to configure the sidelink DRX configuration scheme for the sidelink communication between the UE 102 and the UE 124. For example, as discussed above with reference to FIG. 2, the UE 102 may configure the sidelink DRX configuration scheme based on a first DRX configuration information received from a wireless network access node such as the WANN 118 and the second DRX configuration information. The second DRX configuration may include a subset of a complete set of DRX configuration parameters for configuring sidelink DRX configuration scheme. The second DRX configuration may include, for example, a time duration, an on duration time pattern, a first non-active timer, and a second non-active timer.

Optionally, to collaborate with the UE 102 to utilize the sidelink DRX inactivity timer whose running may indicate the UE 102 and the UE 124 may perform the sidelink communication without DRX. The UE 124 may be configured with a sidelink transmission DRX inactivity timer for the sidelink communication link between the UE 102 and the UE 124. The sidelink transmission DRX inactivity timer may correspond to the sidelink DRX inactivity timer configured to the UE 102 for the sidelink communication link. When the UE 124 receives or transmits a control message, for example via physical sidelink control channel, indicating a new transmission on the sidelink communication link between the UE 102 and the UE 124, the UE 124 may start or restart the sidelink transmission DRX inactivity timer for the sidelink communication link. Additionally or alternatively, when the UE 124 receives or transmits a sidelink DRX Command MAC CE for the sidelink communication link between the UE 102 and the UE 124, the UE 124 may start or restart the sidelink transmission DRX inactivity timer for the sidelink communication link. The UE 124 may receive timer configuration of the sidelink transmission DRX inactivity timer from the WANN 118 or the UE 102.

Optionally, where the UE 124 determines that a selected sidelink grant cannot be used according to the DRX configuration scheme determined by the UE 102, the UE 124 may trigger a sidelink transmission resource reselection. Where the UE 124 determines that a selected sidelink grant falls out of time period during which of the sidelink transmission DRX is not used, the UE 124 may trigger a sidelink transmission resource reselection. Where the UE 124 determines that a selected sidelink grant falls out of running period of the sidelink transmission DRX inactivity timer, the UE 124 may trigger a sidelink transmission resource reselection. Where the UE 124 determines that a selected sidelink grant falls out of running period of a sidelink DRX inactivity timer of the UE 102, the UE 124 may trigger a sidelink transmission resource reselection.

Moreover, the UE 102 may establish sidelink communication links with multiple user equipments such as the UE 124 and the UE 126 and receive data packet from both the UE 124 and the UE 126 via the sidelink communication links. The UE 124 may maintain a sidelink transmission DRX inactivity timer 1 for the sidelink communication link between the UE 102 and the UE 124. The UE 126 may maintain a sidelink transmission DRX inactivity timer 2 for the sidelink communication link between the UE 102 and the UE 126. However, the UE 124 may lack of knowledge on whether the sidelink transmission DRX inactivity timer 2 of the UE 126 is running or not. Similarly, the UE 126 may lack of knowledge on whether the sidelink transmission DRX inactivity timer 1 of the UE 124 is running or not. In the case that the sidelink transmission DRX inactivity timer 1 is stopped while the sidelink transmission inactivity timer 2 is running, the UE 124 may stop transmitting data to the UE 102 while the UE 126 may continue to transmit data to the UE 102. Because the UE 102 needs to receive the data transmitted from the UE 126, the UE 102 may have to monitor all its sidelink communication links including the communication link between the UE 102 and the UE 124. At the point, instead of stopping transmission to wait for a next sidelink DRX on duration for transmission, the UE 124 may actually continue to transmit data to the UE 102. To enable the UE 124 to resume the sidelink transmission, the UE 102 may send indication message to inform the UE 124 to start the sidelink transmission DRX inactivity timer 1 of the UE 124.

In an implementation, the UE 124 may receive a controlling information for the sidelink transmission DRX inactivity timer from the UE 102. The control information may indicate to start or stop the sidelink transmission DRX inactivity timer. Upon receiving the control information, the UE 124 may transmit an acknowledgement of receipt of the controlling information to the UE 102. Then, the UE 124 may start or stop the sidelink transmission DRX inactivity timer according to the controlling message.

In the event that the UE 124 receives a control information indicating to start the sidelink transmission DRX inactivity timer but fails to receive a control information indicating to stop the sidelink transmission DRX inactivity timer subsequently, the UE 124 may stop the sidelink transmission DRX inactivity timer when the sidelink transmission DRX inactivity timer is expired. Additionally or alternatively, the UE 124 may stop the sidelink transmission DRX inactivity timer after a predetermined number of sidelink DRX cycles from the start of the sidelink transmission DRX inactivity timer.

Optionally, in the event that the UE 102 would like to report the sidelink DRX preference, the WANN 118 may configure whether to allow the UE 124 to receive the sidelink DRX preference from the UE 102. In an implementation, the UE 124 may receive the sidelink DRX preference from the UE 102 only when receiving the permission from the WANN 118.

Furthermore, as discussed above with reference to FIG. 2, the sidelink DRX retransmission can be performed between the UE 102 and the UE 124 when a sidelink hybrid automatic repeat request (HARQ) feedback for the sidelink communication link between the UE 102 and the UE 124 is enabled. In an implementation, the UE 124 may receive the indication to enable the HARQ feedback via a sidelink control information, for example, from the WANN 118. As a transmitting UE, the UE 124 may have a plurality of HARQ processes, each of which corresponds to respective data packets to be transmitted via the sidelink communication link between the UE 102 and the UE 124. Upon receiving the indication to enable the HARQ feedback, for each of the HARQ processes, the UE 124 may perform the first repetition of the PSSCH transmission corresponding to the HARQ process to the UE 102 and then start the sidelink transmission DRX HARQ RTT timer, e.g., drx-HARQ-RTT-TimerTxSL. When the sidelink transmission DRX HARQ RTT timer of the HARQ process is expired, the UE 102 may start a sidelink transmission DRX retransmission timer, e.g., drx-RetransmissionTimerTxSL, of the HARQ process. The UE 124 may retransmit a data packet of the HARQ process during running of the sidelink transmission DRX retransmission timer to the UE 102. The UE 124 may receive configurations for the sidelink transmission DRX HARQ RTT timer and the sidelink transmission DRX retransmission timer from the WANN 118 or the UE 102.

Optionally, the UE 124 may be configured with a physical uplink control channel to request for sidelink retransmission resources. To disable the downlink DRX for the downlink between the UE 124 and the WANN 118 during receiving sidelink retransmission resources from the WANN 118, the WANN 118 may configure a downlink sidelink HARQ RTT timer, e.g. drx-HARQ-RTT-TimerSL_DL, and a downlink sidelink retransmission timer, e.g., drx-RetransmissionTimerSL_DL for a sidelink HARQ process. In an implementation, the UE 124 may start the downlink sidelink HARQ RTT timer of the sidelink HARQ process after the transmission of the sidelink HARQ feedback indicating the retransmission is permitted. Then, the UE 124 may start the downlink sidelink retransmission timer of the sidelink HARQ process when the downlink sidelink HARQ RTT timer is expired. During the running of the downlink sidelink retransmission timer, the UE 124 may determine that the downlink DRX for the downlink between the UE 124 and the WANN 118 is not used. The UE 124 may receive the sidelink retransmission resources from the WANN 118 via the downlink without downlink DRX.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a first user equipment in a wireless communication network, comprising:
receiving a first discontinuous reception (DRX) configuration information from a wireless network access node;
receiving a second DRX configuration information from a second user equipment; and
obtaining a DRX configuration scheme for a sidelink communication between the first user equipment and a second user equipment based on the first DRX configuration information and the second DRX configuration information.

2. The method of claim 1, wherein the DRX configuration scheme comprises a plurality of DRX configuration parameters, the obtaining the DRX configuration scheme comprises:
combining DRX configuration parameters in the first DRX configuration information and DRX configuration parameters in the second DRX configuration information into the DRX configuration scheme.

3. The method of claim 2, wherein the combining comprises:
assigning values of DRX configuration parameters in the second DRX configuration information to corresponding DRX configuration parameters in the DRX configuration scheme; and
in response to the second DRX configuration information not including a DRX configuration parameter corresponding to a first DRX configuration parameter in the DRX configuration scheme,
assigning a value of the first DRX configuration parameter in the first DRX configuration information to the first DRX configuration parameter in the DRX configuration scheme.

4. The method of claim 2, wherein combining comprises:
in response to failing to receive the second DRX configuration information from the second user equipment, using the first DRX configuration information as the DRX configuration scheme.

5. The method of claim 1, further comprising:
receiving a third DRX configuration information from a third user equipment; and
the obtaining the DRX configuration scheme comprises:
determining the DRX configuration scheme based on the first DRX configuration information, the second DRX configuration information, and the third DRX configuration information.

6. The method of claim 5, wherein the determining the DRX configuration scheme comprises:
assigning values of DRX configuration parameters in the second DRX configuration information to corresponding DRX configuration parameters in the DRX configuration scheme; and
in response to the second DRX configuration information not including a DRX configuration parameter corresponding to a first DRX configuration parameter in the DRX configuration scheme,
searching the first DRX configuration information and the third DRX configuration information for a second DRX configuration parameter corresponding to the first DRX configuration parameter, and
assigning a value of the second DRX configuration parameter to the first DRX configuration parameter.

7. The method of claim 1, further comprising:
prior to receiving the second DRX configuration information, transmitting the first DRX configuration information to the second user equipment.

8. (canceled)

9. (canceled)

10. The method of claim 1, further comprising:
prior to receiving the first DRX configuration information, transmitting a sidelink information of the first user equipment to the wireless network access node, the sidelink information comprises at least one of quality of service information, destination identity information, or sidelink assistant information.

11. The method of claim 1, wherein the first user equipment is configured with a sidelink DRX inactivity timer for a sidelink communication link between the first user equipment and a second user equipment, the sidelink DRX inactivity timer being running indicates that DRX is not used for the sidelink communication link, the method further comprises:
in response to receiving a sidelink DRX command media access control (MAC) control element (CE) for the sidelink communication link, stopping the sidelink DRX inactivity timer.

12. The method of claim 11, further comprising:
in response to receiving, from the wireless network access node, indication allowing the first user equipment to report a sidelink DRX preference to the wireless network access node, transmitting a sidelink DRX preference for the sidelink communication link to the wireless network access node.

13. (canceled)

14. (canceled)

15. The method of claim 12 or 13, further comprising:
receiving a DRX preference prohibit timer from the wireless network access node or the second user equipment; and
in response to the DRX preference prohibit timer being running, suspending transmitting the sidelink DRX preference to the wireless network access node or the second user equipment until stop of the DRX preference prohibit timer.

16. The method of claim 15, further comprising:
in response to a transmission of a sidelink DRX preference for the sidelink communication link to the wireless network access node or the second user equipment, starting or restarting the DRX preference prohibit timer.

17. The method of claim 1, further comprising:
in response to a sidelink hybrid automatic repeat request (HARQ) feedback being enabled, starting a sidelink DRX HARQ round trip time (RTT) timer of a HARQ process at an end of transmission of the sidelink HARQ feedback; and
in response to a data packet of the HARQ process failing to be decoded,
starting a sidelink DRX retransmission timer of the HARQ process at expiration of the sidelink DRX HARQ RTT timer, and
determining that DRX is not used for the sidelink communication link during running of the sidelink DRX retransmission timer.

18. (canceled)

19. (canceled)

20. A method performed by a first user equipment in a wireless communication network, comprising:
receiving a discontinuous reception (DRX) configuration information from a wireless network access node or a second user equipment; and
obtaining a DRX configuration scheme for a sidelink communication between the first user equipment and a second user equipment based on the DRX configuration information.

21. A method performed by a second user equipment in a wireless communication network, comprising:
transmitting a second discontinuous reception (DRX) configuration information to a first user equipment, which assists the first user equipment to determine a DRX configuration scheme for a sidelink communication between the first user equipment and a second user equipment based on a first DRX configuration information received from a wireless network access node and the second DRX configuration information.

22. The method of claim 21, wherein a second user equipment is configured with a sidelink transmission DRX inactivity timer for a sidelink communication link between the first user equipment and the second user equipment, the method further comprises:
in response to transmission of a control message indicating a new transmission on the sidelink communication link, start or restart the sidelink transmission DRX inactivity timer for the sidelink communication link.

23. The method of claim 22, further comprising:
in response to transmission of a sidelink DRX command media access control (MAC) control element (CE) for the sidelink communication link, starting or restarting the sidelink transmission DRX inactivity timer for the sidelink communication link.

24. (canceled)

25. (canceled)

26. (canceled)

27. (canceled)

28. (canceled)

29. The method of claim 22, further comprising:
receiving a controlling information for the sidelink transmission DRX inactivity timer from the first user equipment; and
controlling the sidelink transmission DRX inactivity timer according to the controlling information.

30. (canceled)

31. The method of claim 29, further comprising:
in response to not receiving a controlling information indicating stopping the sidelink transmission DRX inactivity timer, stopping the sidelink transmission DRX inactivity timer at expiration of the sidelink transmission DRX inactivity timer or after a predetermined number of sidelink DRX cycles from start of the sidelink transmission DRX inactivity timer.

32. (canceled)

33. The method of claim 22, further comprising:
in response to a sidelink hybrid automatic repeat request (HARQ) feedback being enabled, starting a sidelink transmission DRX HARQ round trip time (RTT) timer of a HARQ process at an end of a retransmission for the sidelink HARQ feedback;
starting a sidelink transmission DRX retransmission timer of the HARQ process at expiration of the sidelink transmission DRX HARQ RTT timer; and
retransmitting a data packet of the HARQ process during running of the sidelink transmission DRX retransmission timer.

34. (canceled)

35. (canceled)
